(19) United States
(12) Patent Application Publication
(10) Pub. No.: US 2018/0017245 A1
(43) Pub. Date: Jan. 18, 2018

(54) LIGHTING FIXTURE

(71) Applicant: HABEMIT INTERNATIONAL CO. LTD., Taoyuan City (TW)

(72) Inventors: Chin-Wen WANG, Taoyuan City (TW); Tzu WANG, Taoyuan City (TW)

(21) Appl. No.: 15/603,473

(22) Filed: May 24, 2017

(30) Foreign Application Priority Data
Jul. 12, 2016 (TW) 105121840

(51) Int. Cl. F21V 31/00; F21V 23/06; F21V 15/01

(52) U.S. Cl. CPC F21V 29/673; F21V 31/00; F21V 29/763; F21V 15/01; F21V 23/06

(57) ABSTRACT

A lighting fixture includes a lamp housing, a fan, a heat sink and a light engine. The lamp housing includes an air inlet opening, an air outlet opening and an illumination opening. The fan is installed inside the lamp housing, and the fan includes an air inlet corresponding to the air inlet opening and an air outlet corresponding to the air outlet opening. The heat sink includes a plurality of cooling fins, and each cooling fin is arranged corresponding to directions of the air outlet of the fan and the air outlet opening. The light engine includes one side attached onto a plane surface of the heat sink and another side arranged to face toward a direction of the illumination opening. Accordingly, the use of active cooling method is able to effectively increase the cooling effect of the lighting fixture.

### BACKGROUND OF THE INVENTION

### Field of the Invention

The present invention is related to a lighting fixture, in particular, to a lighting fixture with the utilization of an active cooling method to effectively increase the cooling effect thereof.

### Description of Related Art

Currently, Light Emitting Diodes (LEDs) are widely applied to lighting fixtures of various types of locations. In particular, for high power lighting fixtures, such as the fishing lamps, searchlights at harbors/ports, illumination lamps for large stadiums, stage spot lights, road lamps, decorative lamps and advertisement lamps, all use high power LED lamps. Since the luminance of unit lighting of high power lighting fixtures is great, correspondingly, a great amount of heat is generated during the operation of high power lighting fixtures such that the outer shields of lighting fixtures or the lamp bases of LED lamps are fused and destroyed due to such high temperature, or the high power LED lamps are damaged due to the great amount of heat; therefore, the problem of malfunctions of LED lamp assemblies occur and LED lamps cannot be used any more.

Due to the insufficient cooling ability of currently available high power LED lamps, the developments of high power lighting fixtures have been limited. For some high power LED lamps, in order to install cooling modules, the assembly processes of such lamps tend to become complicated, and the sizes of the lamps are relatively large but the cooling effect is still poor. Therefore, there is indeed a need for an improvement.

In view of the above, to achieve the objective, the inventor seeks to provide a reasonable design capable of effectively improving the aforementioned drawbacks after years of researches along with utilization of academic theories and principles.

### SUMMARY OF THE INVENTION

An objective of the present invention is to provide a lighting fixture utilizing an active cooling method (installation of a fan) to effectively increase the cooling effect.

Another objective of the present invention is to provide a lighting fixture with its size effectively reduced.

To achieve the aforementioned objectives, the present invention provides a lighting fixture, comprising a lamp housing, a fan, a heat sink and a light engine. The lamp housing comprises an air inlet opening, an air outlet opening and an illumination opening. The fan is installed inside the lamp housing, and the fan comprises an air inlet corresponding to the air inlet opening and an air outlet corresponding to the air outlet opening. The heat sink includes a plurality of cooling fins, and each cooling fin is arranged corresponding to directions of the air outlet of the fan and the air outlet opening. The light engine includes one side attached onto a plane surface of the heat sink and another side arranged to face toward a direction of the illumination opening.

The present invention further includes the following advantageous effects. With the installation of fan in the present invention, the heat generated by the LED of the light emitting module can be actively guided out of the lighting fixture as waste heat via the thermal convection method. With the cooling fins arranged on the heat sink at the surface of the light engine, the heat generated by LED can be passively transferred to all cooling fins as waste heat via the thermal conduction method; consequently, the cooling efficiency can be effectively increased. Despite that the lighting fixture of the present invention includes the installation of an active cooling fan, in comparison to currently existing lighting fixtures merely adopting the method of cooling fins for cooling, the present invention is of a reasonable overall structural design such that it is able to effectively reduce the overall size of the lamp housing.

Furthermore, since the direction of the cooling fins of the heat sink is arranged perpendicular to the air outlet opening in the present invention and the direction of each cooling fin is also arranged corresponding to the air outlet of the fan, the airflow blown from the fan is able to actively carry away the waste heat generated by the heat sink out of the air outlet such that the surrounding temperature is not increased due to the blocking and accumulation of heat at the cooling fins or other components. As a result, the cooling effect of the present invention is excellent.

Moreover, the slot of the waterproof pad of the light engine of the present invention is able to engage with the protruding edge of the lens such that water vapor can be prevented from penetrating into the light engine via the bracket such that the waterproof effect is enhanced and the useful lifetime of the light emitting module is increased.

### BRIEF DESCRIPTION OF DRAWING

FIG. 1 is an exploded view of the first preferred embodiment of the present invention;

FIG. 2 is an exploded view of the heat sink and the light engine according to the first embodiment of the present invention;

FIG. 3 is a perspective view of the first preferred embodiment of the present invention;

FIG. 4 is another perspective view of the first preferred embodiment of the present invention;

FIG. 5 is a cross sectional view of the first preferred embodiment of the present invention;

FIG. 6 is another cross sectional view of the first preferred embodiment of the present invention;

FIG. 7 is a perspective view of the second preferred embodiment of the present invention; and

FIG. 8 is another perspective view of the second preferred embodiment of the present invention.

### DETAILED DESCRIPTION OF THE INVENTION

The following provide a detailed description on the technical content of the present invention along with the accompanied drawings. However, it shall be understood that the drawings are provided for illustration purposes only rather than to limit the scope of the present invention.

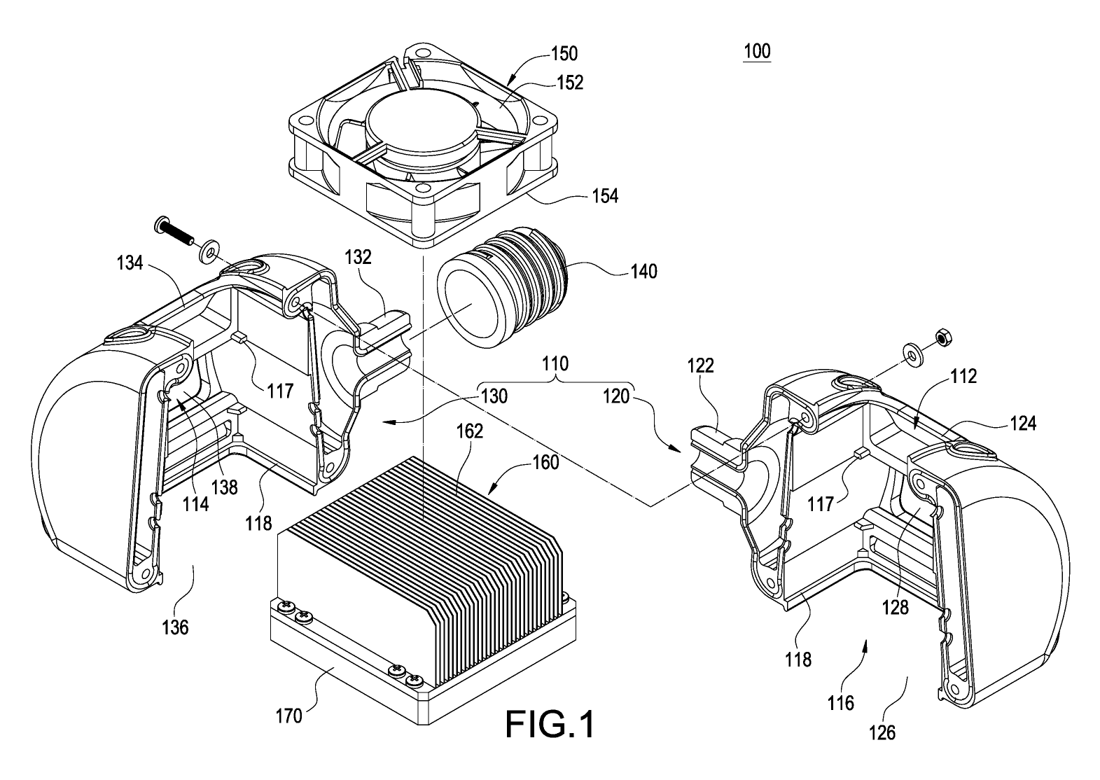

As shown in FIG. 1 to FIG. 6, relevant drawings of a first preferred embodiment of the present invention. The present invention provides a lighting fixture 100, comprising a lamp housing 110, a fan 150, a heat sink 160 and a light engine 170. The lighting fixture 100 disclosed hereafter is preferably applied to a fishing lighting fixture or searchlight lighting fixture for marine uses, ships or ashore uses. However, in other different embodiments, the lighting fixture 100 can also be applied to the uses of illuminating lamps for stadiums/shopping centers, stage spot lights, road lamps, decorative lamps or advertisement signboards etc. such that it is not limited to a particular application only.

The lamp housing 110 comprises an air inlet opening 112, an air outlet opening 114 and an illuminating opening 116. In a first preferred embodiment, the lamp housing 110 further comprises a first housing member 120 and a second housing member 130 attached onto each other. The first housing member 120 further includes a first column portion 122, a first hole 124 and a second hole 126 corresponding to the first hole 124 and a first exhaust vent 128 arranged perpendicularly to a direction of the first hole 124. The second housing 130 includes a second column portion 132, a third hole 134 and a fourth hole 136 corresponding to the third hole 134 as well as a second exhaust vent 138 arranged perpendicular to a direction of the third hole 134. The first housing member 120 and the second housing member 130 are attached onto each other, followed by using fastening elements, such as screws or bolts etc., for fastening.

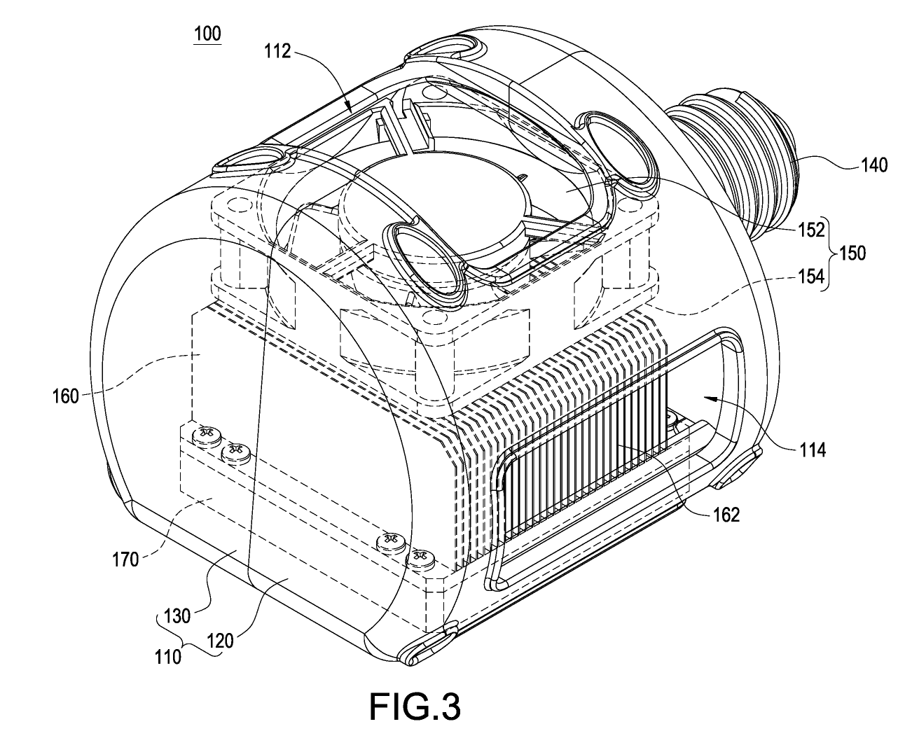

In the embodiment as shown in FIG. 3 to FIG. 6, the first hole 124 and the third hole 134 are arranged corresponding to each other and can be attached onto each other to form the aforementioned air inlet opening 112. The second hole and the fourth hole are arranged corresponding to each other and can be attached onto each other to form the aforementioned illuminating opening 116. The first exhaust vent 128 and the second exhaust vent 138 form the aforementioned air outlet openings 114, meaning that in this embodiment, it is preferably to have two corresponding air outlet openings 114. The shape of the air inlet opening 112 and the air outlet opening 114 after the attachment thereof is preferably to be of a rectangular shape. The shape of the illuminating opening 116 is preferably of a circular shape; however, in other different embodiments, the shapes of the air inlet opening 112, the air outlet opening 114 or the illuminating opening 116 can be varied depending upon different requirements, and the present invention shall not be limited to this embodiment only.

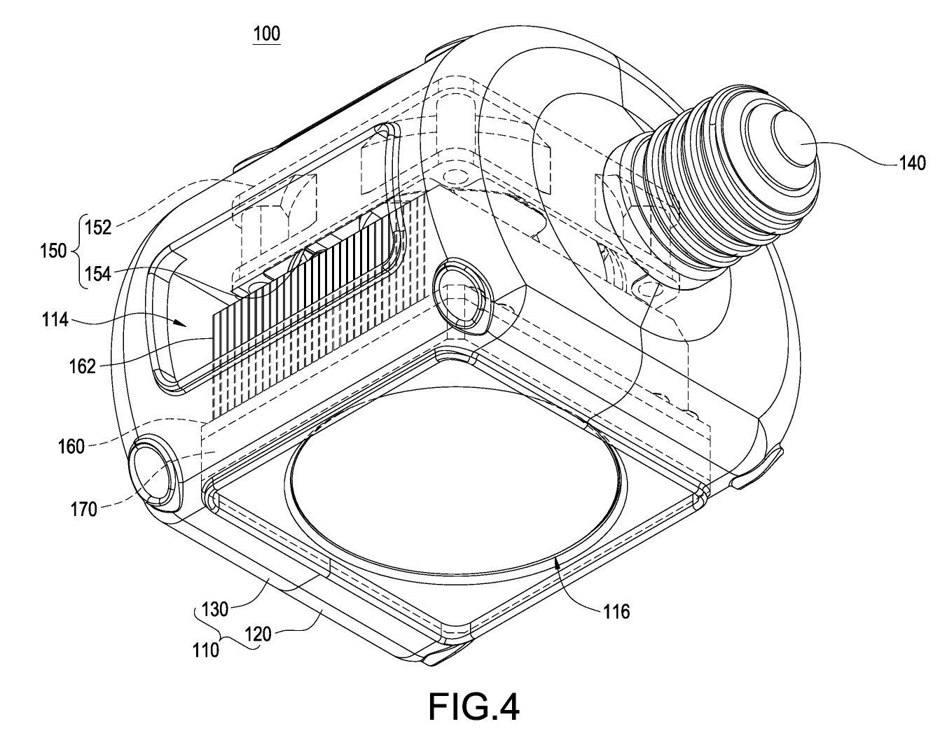

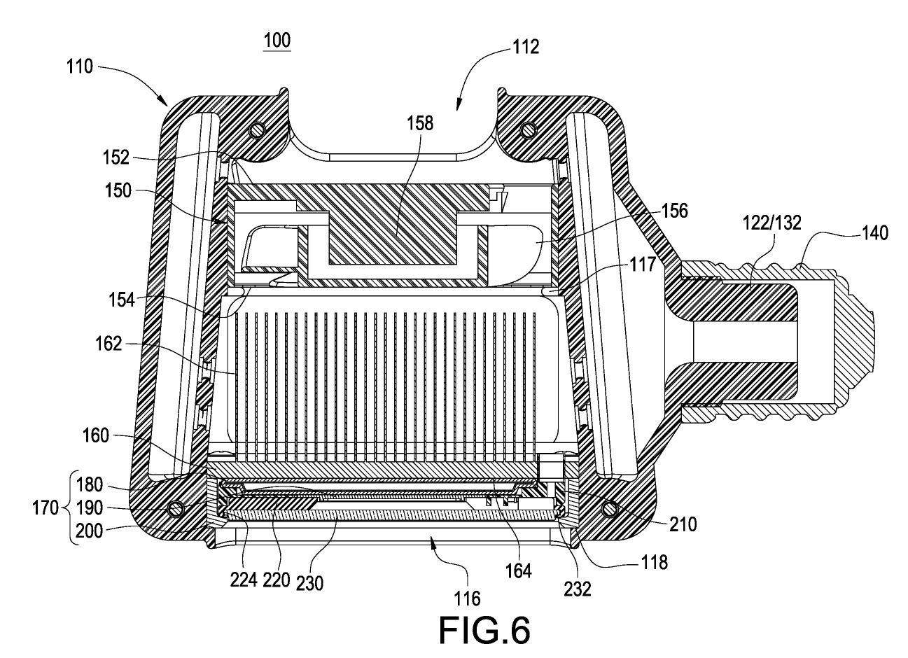

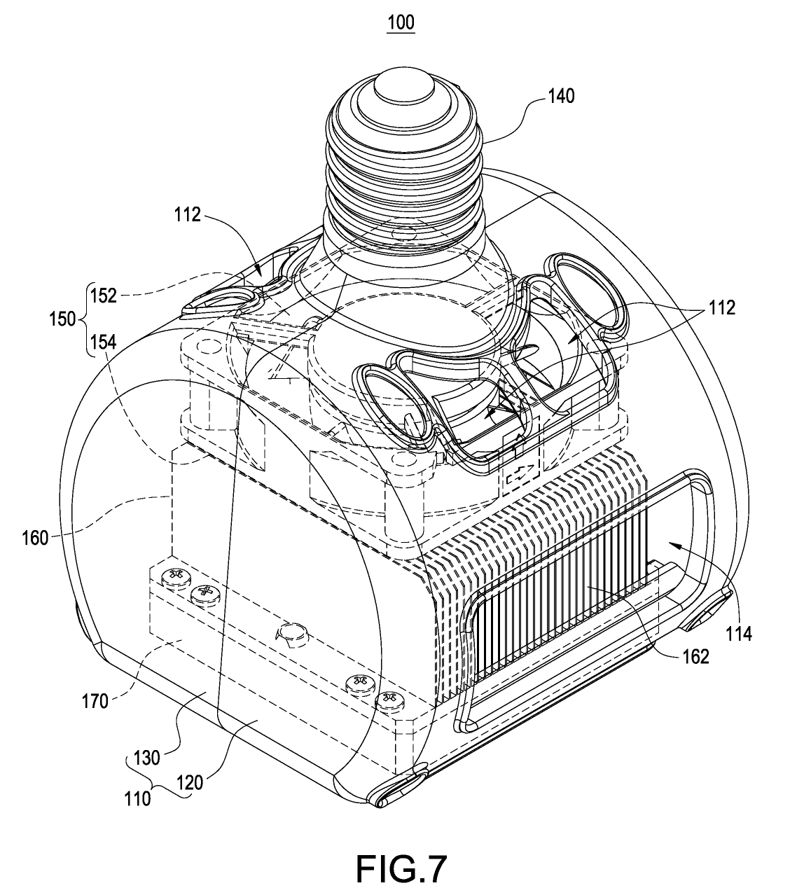

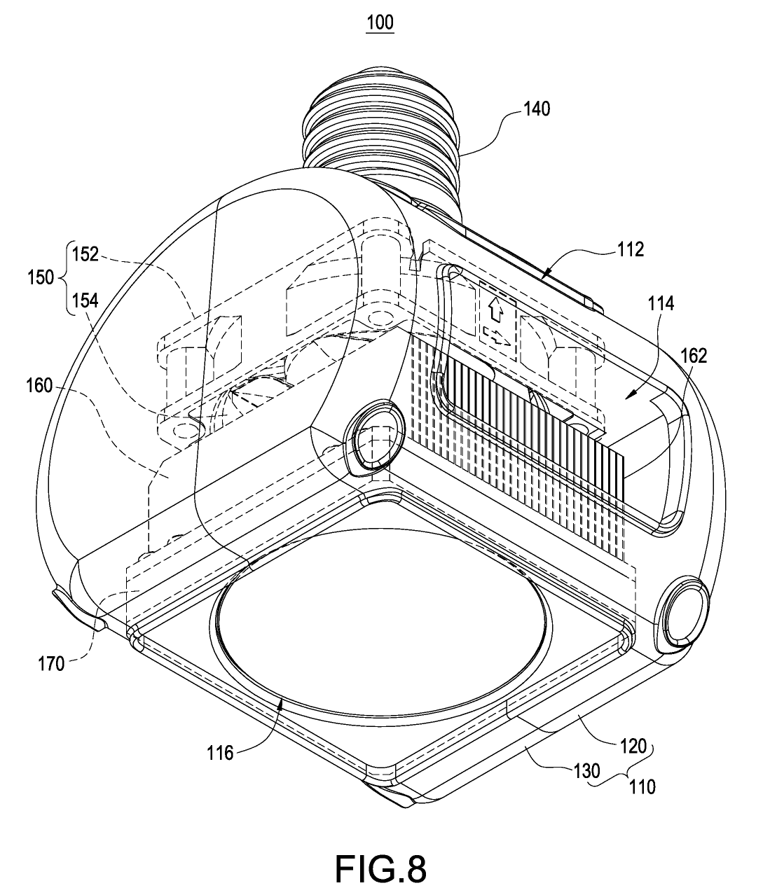

In this embodiment, it further includes an electrical connector 140 assembled onto the first column portion 122 and the second column portion 132. As shown in the drawings, the electrical connector 140 is preferably to be a connector with external threads for fastening on a socket (not shown in the drawings). However, in other different embodiments, the electrical connector 140 can also be a plug (not shown in the drawings) such that it can be directly plugged onto the socket (not shown in the drawings). Furthermore, as shown in FIG. 4 or FIG. 6, the extension direction of the electrical connector 140 is preferably perpendicular to the illumination direction of the illumination opening 116. However, in the embodiments shown in FIG. 7 and FIG. 8, the extension direction of the electrical connector 140 can also be parallel to the illumination direction of the illumination opening 116. Accordingly, the illumination direction related to the illumination opening 116 of the lamp housing 110 can be varied depending upon the needs such that the present invention is not limited to such directions only.

The fan 150 is installed inside the lamp housing 110. The fan 150 comprises an air inlet 152 corresponding to the air inlet opening 112 and an air outlet 154 connected to the air outlet opening 114. In this embodiment, the fan 150 is preferably an axial-flow fan, meaning that the direction of the air inlet 152 is parallel to the direction of the axle 158 of the fan 150 in order to allow the airflow to enter from another end of the air inlet 152 and to be blown out in a direction parallel to the axle 158. The heat sink 160 includes a plurality of cooling fins 162, and each cooling fin 162 is arranged corresponding to the directions of the air outlet 154 of the fan and the air outlet opening 114. To be more specific, the top surface of each cooling fin 162 is arranged corresponding to the air outlet 154 of the fan 150, and the two side surfaces of each cooling fin 162 are arranged corresponding to the two air outlet openings 114 of the lamp housing 110 in order to allow the flow of the air to be effectively and reasonably exhausted form the internal of the lamp housing 110 toward the direction of the two air outlet openings 114, wherein the direction of the air outlet 154 and the direction of the air outlet opening 114 are perpendicular to each other.

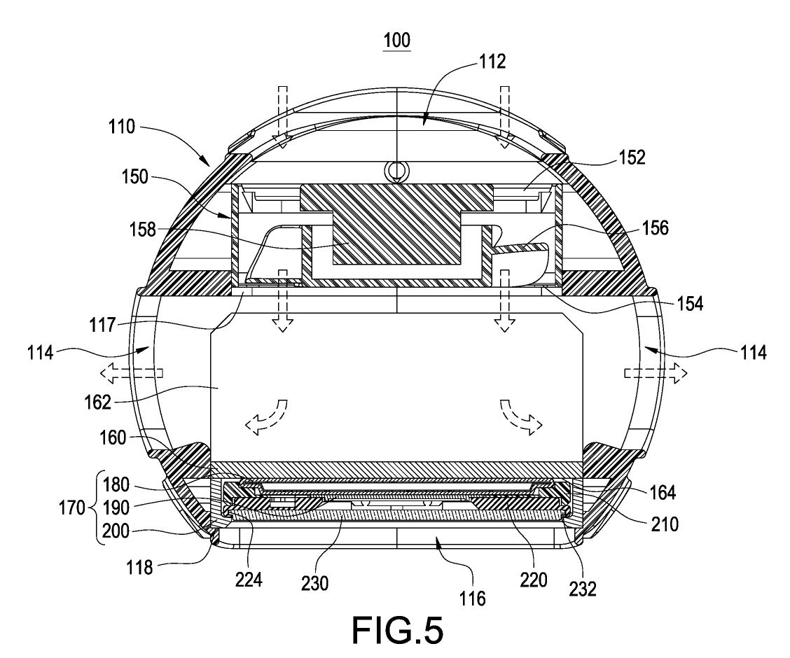

During the use of the lighting fixture 100 of this embodiment, the blade 156 of the fan 150 rotates in order to guide the air to enter from the air inlet opening 112 into the lamp housing 110 and to flow toward each cooling fin 162 of the heat sink 160 until the waste heat generated by each cooling fin 162 is carried away from the air outlet openings 114. As shown in FIG. 5 and FIG. 6, in particular, the arrangement direction of each cooling fin 162 is perpendicular to the two air outlet openings 114 in order to allow the airflow blown by the fan 150 to carry away the waste heat generated by the heat sink 160 out of the air outlet openings 114 such that the surrounding temperature is not increased due to the blocking by the cooling fins 162 or other components. Consequently, the cooling effect of the embodiment is excellent.

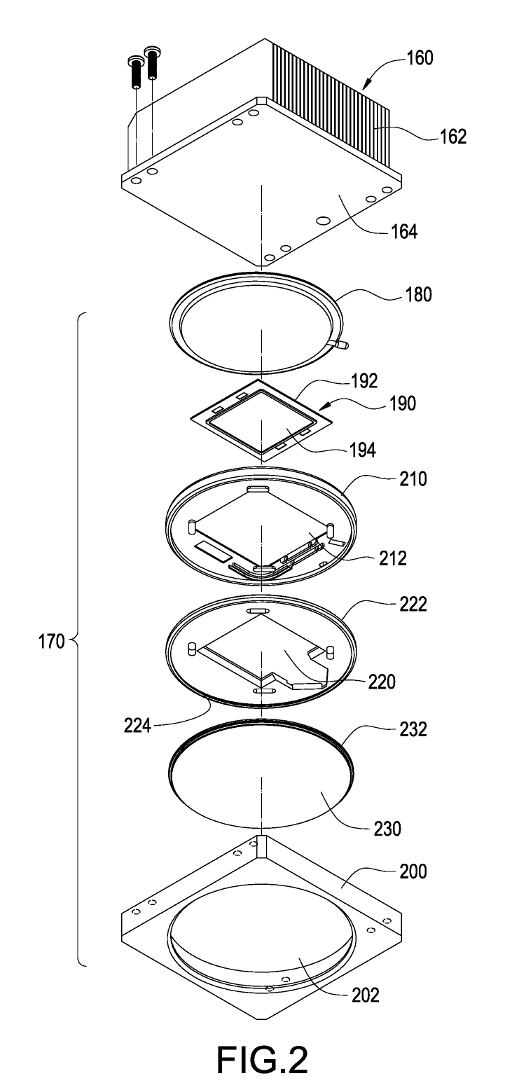

As shown in FIG. 2, FIG. 5 and FIG. 6, the heat sink 160 is preferably to be made of a material of excellent thermal conductivity such as aluminum extrusion material, copper material other appropriate metal composite material. Another side of each cooling fin 162 facing toward each other is a smooth plane surface 164. One side of the light engine 170 is attached onto the plane surface 164 of the heat sink 160, and another side thereof is arranged toward the direction of the illumination opening 116.

As shown in FIG. 2, the light engine 170 further comprises a vapor chamber unit 180, a light emitting module 190 and a bracket 200. The vapor chamber 180 having a working fluid (not shown in the drawings) and a capillary structure (not shown in the drawings) arranged at an internal thereof is attached onto the plane surface 164 of the heat sink 160, and the light emitting module 190 abuts against one side of the vapor chamber unit 180 in order to allow the waste heat generated by the light emitting module 190 to be thermally conducted to the heat sink 160. The bracket 200 covers the vapor chamber unit 180 and the light emitting module 190, and fastening elements of screw bolts etc. are used for positioning it onto the heat sink 160.

In the embodiment as shown in FIG. 2, the light emitting module 190 further comprises a circuit board 192 and at least one LED 194 electrically coupled to the circuit board 192. The light engine 170 further comprises a cover plate 210 positioned on the vapor chamber unit 180 and the light emitting module 190, a waterproof pad 220 stacked onto the cover plate 210 and a lens 230 disposed between the bracket 200 and the light emitting module 190. As shown in FIG. 5 and FIG. 6, one side of the cover plate 210 made of a plastic or metal material includes the vapor chamber unit 180 positioned thereon and another side thereof includes the waterproof pad 220 locked thereon. The cover plate 210 further comprises a first through hole 212, and the waterproof pad 220 comprises a second through hole 222 corresponding to the first through hole 212. The dimension of the first through hole corresponds to the dimension of the light emitting module. The bracket 200 further comprise a third through hole 202 arranged corresponding to the illumination opening 116 in order to allow the light of LED to penetrate through the lens 230 in order to be projected outward from the third through hole 202 with more uniform lighting and at a greater angle.

In addition, the waterproof pad 220 preferably made of a rubber or silicon material further includes a slot 224 formed thereon, and the edge of the lens 230 is a protruding edge 232 in order to allow the slot 224 of the waterproof pad 220 to enclose the protruding edge 232 of the lens 230 such that water vapor cannot penetrate into the light engine 170 via the third through hole 202 in order to increase waterproof effect as well as to increase the useful lifetime of the light emitting module 190.

Please refer to FIG. 7 and FIG. 9 showing perspective views of a second preferred embodiment of the present invention viewed from different angles. In this embodiment, the main difference from the first embodiment relies in that the electrical connector 140 is connected to one end of the lamp housing 110, meaning that its extension direction is parallel to the illumination direction of the illumination opening 116. Since the electrical connector 140 is assembled at the direction of the air inlet opening 112 of the lamp housing 110, the location of the original air inlet opening 112 needs to be moved to the two sides of the electrical connector 140, meaning that the air inlet openings 112 of the first housing member 120 and the second housing member 130 are arranged at two sides adjacent to the top of the air inlet 152 of the fan 150 in order to facilitate the fan 150 to guide the air to enter into the lamp housing 110 via the air inlet openings 112. The remaining technical effects and structure are identical to the ones of the first embodiment previously mentioned such that details thereof are omitted.

Particularly, it shall be noted that the lamp housing 110 further comprises two first retaining pieces 117 and two second retaining pieces 118. Each one of the first retaining pieces 117 is used for stably positioning the fan 150, and each one of the second retaining pieces 118 is used for stably positioning the light engine 170. Each one of the first retaining pieces 117 and each one of the second retaining pieces 118 are preferably protruding blocks integrally formed at the inner wall of the first housing member 120 and the second housing member 130 respectively; however, their structures can also be protruding strips or other suitable shapes such that the present invention is not limited any particular shapes thereof.

The present invention utilizes an active fan 150 along with a passive heat sink 160 and the arrangement of the elements of the vapor chamber unit 180 etc. in order to rapidly transfer the heat generated by the LED of the light emitting module 190 to the cooling fins 162 via the method of conduction heat transfer, followed by exhausting the heat to the external of the lamp housing 110 via the method of convention heat transfer. As a result, the cooling effect of the lighting fixture 100 of the present invention is effectively increased.

In addition, despite that the lighting fixture 100 of the present invention includes the installation of a fan for active cooling, in comparison to the currently existing lighting fixtures using cooling fins as means for cooling, the present invention is of a reasonable overall structural design such that it is able to effectively reduce the overall size of the lamp housing 110.

In view of the above, the embodiments of the present invention disclosed shall be considered to illustrate the present invention only rather than to limit the present invention. The scope of the present invention shall be determined based on the claims defined hereafter, and the scope of the present invention shall cover all equivalent modifications such that it shall not be limited to the descriptions provided above.

What is claimed is:

1. A lighting fixture, comprising:
a lamp housing comprising an air inlet opening, an air outlet opening and an illumination opening;
a fan installed inside the lamp housing, and the fan comprising an air inlet corresponding to the air inlet opening and an air outlet corresponding to the air outlet opening;
a heat sink having a plurality of cooling fins, and each cooling fin arranged corresponding to directions of the air outlet of the fan and the air outlet opening; and
a light engine having one side attached onto a plane surface of the heat sink and another side arranged to face toward a direction of the illumination opening.

2. The lighting fixture according to claim 1, wherein the lamp housing further comprises a first housing member and a second housing member attached onto each other.

3. The lighting fixture according to claim 2, wherein the first housing member further includes a first column portion, a first hole, a second hole corresponding to the first hole and a first exhaust vent arranged perpendicular to a direction of the first hole; the second housing member includes a second column portion, a third hole and a fourth hole corresponding to the third hole and a second exhaust vent arranged perpendicular to a direction of the third hole.

4. The lighting fixture according to claim 3, further comprising an electrical connector installed on the first column portion and the second column portion.

5. The lighting fixture according to claim 1, further comprising an electrical connector connected to one end of the lamp housing; wherein an extension direction of the electrical connector is arranged perpendicular or parallel to an illumination direction of the illumination opening.

6. The lighting fixture according to claim 1, wherein the lamp housing further comprises two first retaining pieces and two second retaining pieces; each one of the first retaining pieces is provided for positioning the fan, and each one of the second retaining pieces is provided for positioning the light engine.

7. The lighting fixture according to claim 1, wherein the light engine further comprises:
a vapor chamber unit attached onto the plane surface of the heat sink;
a light emitting module abutted against one side of the vapor chamber unit; and
a bracket covering the vapor chamber unit and the light emitting module as well as positioned on the heat sink.

8. The lighting fixture according to claim 7, wherein the light emitting module further comprises a circuit board and at least one LED electrically coupled to the circuit board.

9. The lighting fixture according to claim 7, further comprising a cover plate positioned on the vapor chamber unit and the light emitting module as well as a waterproof pad stacked onto the cover plate.

10. The lighting fixture according to claim 9, wherein the one side of the cover plate includes the vapor chamber unit positioned thereon and another side thereof includes the waterproof pad locked thereon.

11. The lighting fixture according to claim 9, wherein the cover plate further comprises a first through hole, the waterproof pad further comprises a second through hole corresponding to the first through hole; a dimension of the first through hole corresponds to a dimension of the light emitting module.

12. The lighting fixture according to claim 7, wherein a lens is disposed between the bracket and the light emitting module.

13. The lighting fixture according to claim 7, wherein the bracket further comprises a third through hole arranged corresponding to the illumination opening.

14. The lighting fixture according to claim 1, wherein the fan is an axial-flow fan.
